(19) United States
(12) Patent Application Publication
(10) Pub. No.: US 2022/0146544 A1
(43) Pub. Date: May 12, 2022

(54) NORMALIZING FLUID IN A FLUIDIC DEVICE

(71) Applicant: Hewlett-Packard Development Company, L.P., Spring, TX (US)

(72) Inventors: Diane R. Hammerstad, Corvallis, OR (US); Jeffrey A. Nielsen, Corvallis, OR (US); Christie Dudenhoefer, Corvallis, OR (US); Matthew Smith, Corvallis, OR (US)

(73) Assignee: Hewlett-Packard Development Company, L.P., Spring, TX (US)

(21) Appl. No.: 17/414,031

(22) PCT Filed: Jul. 31, 2019
(86) PCT No.: PCT/US2019/044335

§ 371 Date: Jun. 15, 2021

(51) Int. Cl. G01N 35/10; B01L 3/02

(52) U.S. Cl. CPC G01N 35/1016; G01F 22/00; B01L 3/0268

(57) ABSTRACT

Aspects of the present disclosure relate to evaporation compensation in fluidic devices. An example apparatus for evaporation compensation includes an assessment circuit to determine an amount of evaporation of a volume dispensed in a microwell of a fluidic device. The amount of evaporation may be determined based on the volume in the microwell, and an amount of time after dispensing the volume in the microwell. A compensation circuit may determine, based on the amount of evaporation, a compensation factor for the microwell including an amount of a normalizing fluid to compensate for the amount of evaporation. The compensation circuit may also create a normalization profile for the fluidic device, including an association between the fluidic device and the compensation factor. A dispensing circuit may dispense the normalizing fluid in the microwell according to the normalization profile.

### BACKGROUND

Microfluidic systems enable fluid-based experiments to be conducted using much smaller quantities of fluid as compared to microtiter plate-based experiments. These small volumes enable advantages such as a reduction in expensive chemicals used, a reduction in the amount of patient sample needed which makes sample collection easier and less intrusive, a reduction in the amount of waste generated, and in some cases a reduction in the time for processing, such as temperature cycling of a sample.

### BRIEF DESCRIPTION OF FIGURES

Various examples may be more completely understood in consideration of the following detailed description in connection with the accompanying drawings, in which:

FIG. 1A illustrates an example apparatus for normalizing fluid in a fluidic device, consistent with the present disclosure;

FIGS. 1B and 1C illustrate exploded views of a cassette for normalizing fluid in a fluidic device, consistent with the present disclosure;

FIG. 2 is a diagram illustrating an example computing apparatus for normalizing fluid in a fluidic device, consistent with the present disclosure; and

FIG. 3 is a flow chart illustrating an example method for normalizing fluid in a fluidic device, in accordance with the present disclosure.

While various examples discussed herein are amenable to modifications and alternative forms, aspects thereof have been shown by way of example in the drawings and will be described in detail. It should be understood, however, that the intention is not to limit the disclosure to the particular examples described. On the contrary, the intention is to cover all modifications, equivalents, and alternatives falling within the scope of the disclosure including aspects defined in the claims. In addition, the term “example” as used throughout this application is only by way of illustration, and not limitation.

### DETAILED DESCRIPTION

The life sciences research and diagnostics industries are under pressure to reduce costs, increase throughput, and improve the utilization of patient samples. As a result, the instruments and tools used therein are moving from complex macrofluidic-based systems to simpler microfluidic-based technology, moving from pipetting-based technology to dispensing-based technology, and moving from performing a single test per sample to performing multiplexed tests per sample.

Inkjet-based systems can start with microliters of fluid and then dispense picoliters or nanoliters of fluid into specific locations on a substrate. These dispense locations can be either specific target locations on the substrate surface or can be cavities, microwells, channels, or indentations into the substrate. As used herein, a microwell refers to or includes a column capable of storing a volume of fluid between a nanoliter and several milliliters of fluid. There may be tens, hundreds, or even thousands of dispense locations on the substrate, which may represent many tests on a small number of samples, a small number of tests on many samples, or a combination of the two. Additionally, multiple dispensing nozzles or print heads may dispense fluid on the substrate at a time to enable a high-throughput design. As the number of dispense locations can be 100s or 1000s of times the number of active dispensing nozzles or print heads, the time between the dispensing of the first and last wells in the substrate can be many seconds or even many minutes. Based on the difference in the amount of elapsed time between dispensing and testing, the amount of fluid in the first wells may be less than the amount of fluid in the last wells.

In accordance with examples of the present disclosure, an apparatus including an assessment circuit, a compensation circuit, and a dispensing circuit may compensate for varied evaporation among microwells on a substrate. The assessment circuit may determine an amount of evaporation of a volume dispensed in a microwell of a fluidic device, where the amount of evaporation is determined based on the volume in the microwell, and an amount of time after dispensing the volume in the microwell. The compensation circuit may determine, based on the amount of evaporation, a compensation factor for the microwell including an amount of a normalizing fluid to compensate for the amount of evaporation. The compensation circuit may also create a normalization profile for the fluidic device, including an association between the fluidic device and the compensation factor. The dispensing circuit may dispense the normalizing fluid in the microwell according to the normalization profile.

In an additional example, a non-transitory computer-readable storage medium storing instructions that, if executed, may cause a processor to compensate for evaporation in a fluidic device. The instructions may cause the processor to identify a type of fluidic device received by a test system, and a test protocol associated with the fluidic device. Further instructions may cause the processor to determine, for each microwell among a plurality of microwells in the fluidic device, an amount of evaporation of a volume dispensed in the respective microwell, based on the volume in the respective microwell, and an amount of time after dispensing the volume in the respective microwell. Additional instructions, when executed, may cause the processor to determine, for each microwell among the plurality of microwells, a compensation factor for the respective microwell including an amount of a normalizing fluid to compensate for the amount of evaporation. A normalization profile may be created for the fluidic device, including an association between the type of fluidic device and the compensation factors for the plurality of microwells, and the processor may dispense the normalizing fluid in the plurality of microwells and according to the normalization profile.

In further examples, a method for normalizing fluid in a fluidic device includes estimating for each microwell among a plurality of microwells in a fluidic device, an amount of evaporation of a volume dispensed in the respective microwell, based on the volume in the respective microwell, and an amount of time after dispensing the volume in the respective microwell. A compensation factor for each respective microwell may be determined, including an amount of a normalizing fluid to compensate for the amount of evaporation. Moreover, a normalization profile may be identified for the fluidic device, including an association between the fluidic device and the compensation factors for the plurality of microwells, and the normalizing fluid may be dispensed in the plurality of microwells and according to the normalization profile.

In the following description various specific details are set forth to describe specific examples, with the understanding that other examples may be practiced without all the specific details given below and that features from figures/examples can be combined with features of another figure or example even though the combination is not explicitly shown or explicitly described as a combination. For ease of illustration, the same reference numerals may be used in different diagrams to refer to the same elements or additional instances of the same element.

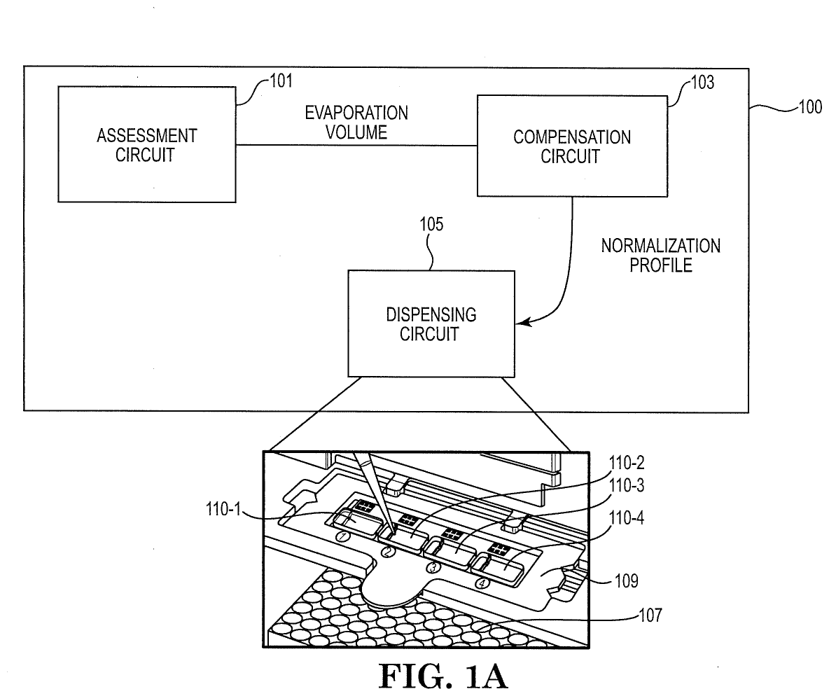

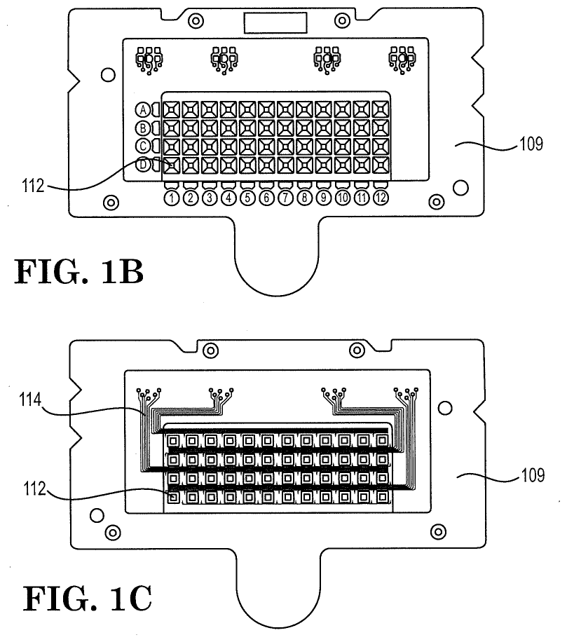

Turning now to the Figures, FIG. 1A illustrates an example apparatus 100 for normalizing fluid in a fluidic device, consistent with the present disclosure. In order to compensate for evaporation, the apparatus 100 may determine how much evaporation occurs during a dispense operation. As described herein, a fluidic device 107 (also referred to as a microfluidic device) may include a substrate or plate and a plurality of channels, indentations, and/or microwells. Each microwell of the fluidic device 107 may hold somewhere between a nanoliter and several milliliters of liquid. Because the number of dispense locations can be 100s or 1000s of times the number of active dispensing nozzles or print heads, the time between the dispensing of the first and last wells in the fluidic device 107 may be many seconds or even many minutes. Therefore, the resultant amount of fluid in the first wells may be less than the amount of fluid in the last wells due to evaporation.

In accordance with the present disclosure, the apparatus 100 may include an assessment circuit 101 to determine an amount of evaporation of a volume dispensed in a microwell of a fluidic device 107. The amount of evaporation, or evaporation volume, is determined based on the volume in the microwell, and an amount of time after dispensing the volume in the microwell. This can be done either via evaporation modeling or via empirical measurement. In fluidic devices used for diagnostics, the same filling operation and sequence may be used repeatedly and consistently. Thus, if evaporation is characterized for a particular fluidic device and a particular protocol, then a consistent normalization profile can be applied to that device for future protocols.

A compensation circuit 103 may determine, based on the amount of evaporation, a compensation factor for the microwell including an amount of a normalizing fluid to compensate for the amount of evaporation. The compensation factor may be applied to the original protocol to create an adjusted protocol. One adjustment may be to dispense more fluid into the first well and less fluid into the last well (and a range of dispense volumes in between). However, a system that does this may end up with the same amount of fluid in all wells but will have a higher concentration of the chemicals or sample of interest in the first well and a lower concentration in the last well. The compensation circuit 103 may also create a normalization profile for the fluidic device 107, including an association between the fluidic device and the compensation factor. A dispensing circuit 105 may dispense the normalizing fluid in the microwell according to the normalization profile.

In some examples, the volume dispensed in the microwell of the fluidic device 107 may include a test sample. The dispensing circuit 105 may further include a test sample dispensing circuit to dispense the test sample in the microwell and a normalization dispensing circuit (not illustrated) to dispense the normalization fluid in the microwell according to the normalization profile.

As described herein, a normalizing fluid may be added to the microwell(s) to compensate for the amount of evaporation in the associated microwell. While the first volume may contain a test sample and/or various chemicals associated with operation of the fluidic device 107, the normalizing fluid refers to or includes a fluid that does not contain a test sample or chemicals associated with operation of the fluidic device. Non-limiting examples of normalizing fluid include buffer, saline, oil, and Master Mix. In some examples, the normalizing fluid may be neat water or solvent. Additionally and/or alternatively, the normalizing fluid may include complimentary components to help the jetting or to minimize the evaporation of the test sample, such as surfactants, humectants, or viscosity agents, such as glycerol. In some examples, the same normalizing fluid can be used to normalize more than one test fluid. Moreover, the drop volume of the normalizing fluid may be different than the drop volume of the test fluid, based on the design of the resistors, bores and firing chambers of the dispensing device filling the microwells.

In some examples, the apparatus 100 includes two fluids and two or more nozzles capable of dispensing these two fluids. For instance, using a cassette 109 including a plurality of fluid ejectors, the fluids may be ejected into or onto the fluidic device 107. The cassette may include one or more pieces of Silicon. Additionally, a plurality of fluids, each fed with different reservoirs, slots, and/or fluidic paths, may be dispensed via cassette 109. As an illustration, the cassette 109 may include one piece of silicon that may be fed by two or more fluids via multiple reservoirs (110-1, 110-2, 110-3, and 110-4), such as test sample and a normalizing fluid, or test sample and an oil, or test sample, normalizing fluid and an oil. For instance, reservoir 110-1 may dispense a test sample, and reservoir 110-2 may dispense a normalizing fluid, reservoir 110-3 may dispense an oil, and reservoir 110-4 may dispense another fluid. Additionally and/or alternatively, there may be separate and discrete pieces of silicon with different respective fluid ejectors for each fluid to be ejected by apparatus 100. For instance, referring to FIG. 1A, cassette 109 may include a plurality of fluid ejectors for dispensing a first fluid, and a separate cassette (not illustrated in FIG. 1A) may dispense a second fluid.

The cassette 109, or multiple cassettes as the case may be, may each include a plurality of reservoirs (111-1, 111-2, 111-3, and 111-4) which provide fluid to a plurality of fluid ejectors (or nozzles). Using apparatus 100, the cassette 109 may move to different locations, rows, and/or columns of the fluidic device 107 to dispense the associated fluid. For instance, as illustrated in FIG. 1A, the fluidic device 107 may be a microwell plate, and the fluid ejectors in cassette 109 may dispense fluid into each of the wells within the microwell plate illustrated: Additionally and/or alternatively, the fluidic device 107 may be a microfluidic chip or other substrate, as described herein.

In various examples, additional fluid may be added to the microwells to prevent evaporation. For instance, after a fluid sample is added to each of the microwells of the fluidic device 107, an oil from the same cassette 109 or a different cassette, may be ejected onto the surface of the fluid sample in the microwells. The oil may suppress evaporation from the test sample by creating a barrier to the ambient air above the test sample.

FIG. 1B and FIG. 1C illustrate exploded views of a cassette for normalizing fluid in a fluidic device, consistent with the present disclosure. FIG. 1B illustrates the top side of the cassette, such as 109 illustrated in FIG. 1A, in which fluid is filled from reservoirs (such as reservoirs 110-1, 110-2, 110-3, and 110-4 illustrated in FIG. 1A). In the example illustrated in FIG. 1B, the cassette 109 includes four (4) rows of twelve (12) fluid ejectors 112, which may in some examples may be thermal inkjet (TIJ) resistors. Above each of the ejectors 112, a reservoir (such as reservoirs 110-1, 110-2, 110-3, and 110-4 illustrated in FIG. 1A) may provide the fluid for dispensing. For instance, each of the ejectors 112 in columns 1, 2, and 3 may be provided fluid by reservoir 110-1, each of the ejectors 112 in columns 4, 5, and 6 may be provided fluid by reservoir 110-2, and so forth. Additionally and/or alternatively, each ejector 112 may be provided fluid independent of the other ejectors 112. For instance, ejector 1-D (column 1, row D) may be provided a first fluid for dispensing into/onto fluidic device 107, ejector 2-C (column 2, row C) may be provided a second fluid for dispensing into/onto fluidic device 107, and ejector 12-B (column 12, row B) may be provided a third fluid for dispensing into/onto fluidic device 107.

FIG. 1C illustrates the bottom side of the cassette, which ejects the fluid into or onto the fluidic device 107. As illustrated in FIG. 1B, each row of fluid ejectors 112 may be connected to the other rows and columns of fluid ejectors by electrical traces 114, such that firing of the fluid ejectors, and therefor ejection of the respective fluids, may be coordinated.

Apparatus 100 may be capable of dispensing, analyzing, and correcting for errors in the dispensing of fluids onto the fluidic device 107. Using the ability to independently operate fluid ejectors on the cassette 109, or to independently operate an array of fluid ejectors, one example of the apparatus 100 uses an analysis and correction process to ensure accuracy of the fluid dispensed into or onto fluidic device 107. For instance, an initial set of instructions, or a test protocol, may provide the initial dispensing instructions from fluid ejectors 112 into microwells of the fluidic device 107. This initial set of instructions, or test protocol, may have one or more fluid ejectors 112 dispensing either the same or variable amounts of fluid into each of the microwells. The apparatus 100 may further include an accuracy circuit to assess or measure the presence or quantity of volume of fluid in each of the dispensed microwells. This may be done via optical assessment, laser profilometry, fluorescence, and/or other measurement techniques. In some examples, the apparatus 100 may assess whether the microwells show presence or absence of fluid. In other examples, the apparatus 100 may assess the quantity of fluid in each microwell.

Because fluid in a microwell may form a meniscus within the well, the measure of the fluid in each microwell may be measured by measuring the shape or depth of the meniscus in the respective microwell. Based on the shape or depth of the meniscus, the apparatus 100, such as using the compensation circuit 103, may generate a set of compensation instructions to compensate for variations in the initial dispensing, or to ‘top off’ the microwells that were either missed or low in the initial dispense. The apparatus 100 may use the compensation instructions by dispensing from fluid ejectors into specified microwells. As the compensation instructions provide added fluid to account for variations in dispensing volumes, the compensation instructions may indicate that different amounts of fluid is dispensed into each microwell, including perhaps ejecting zero fluid into a particular microwell.

In some examples, the compensation circuit 103 may determine a compensation factor for a particular assay performed by the fluidic device. For instance, a particular cartridge may be placed in the apparatus 100 and a particular assay to be performed may be detected. Based on the identification of the cartridge and/or assay to be performed, the apparatus 100 may estimate an amount of evaporation for each well in the fluidic device 107 for the particular assay. Additionally, the amount of evaporation may be determined based on the size of the fluidic device 107, including a number of microwells on the fluidic device 107 and/or a number of the microwells being utilized for the particular assay. As such, the compensation circuit 103 may determine a compensation factor for the microwell(s) including an amount of a normalizing fluid to compensate for the amount of evaporation for a particular type of fluidic device and/or the particular assay to be performed.

Additionally, various normalization profiles may be stored by the apparatus 100 for subsequent retrieval and implementation. For instance, the apparatus 100 may include a memory (not illustrated in FIG. 1). The memory 100 may store normalization profiles determined by the compensation circuit. In response to identifying a particular device and/or assay, and a normalization profile associated with the identified device or assay, the apparatus 100 may use the assessment circuit 101 to retrieve the normalization profile from the memory in response to identification of the fluidic device. The dispensing circuit 105 may dispense the normalization fluid in response to retrieval of the normalization profile from the memory.

Evaporation compensation in fluidic devices, in accordance with the present disclosure, may improve the number of wells dispensed to within volumetric accuracy and or sample concentration specification.

In some examples, the spacing between sample nozzles and normalization nozzles matches the spacing between microwells on the fluidic device. This may allow for simultaneous dispensing of test fluid and normalization fluid, albeit into different wells. This enables the normalization to take place without additional time for dispensing.

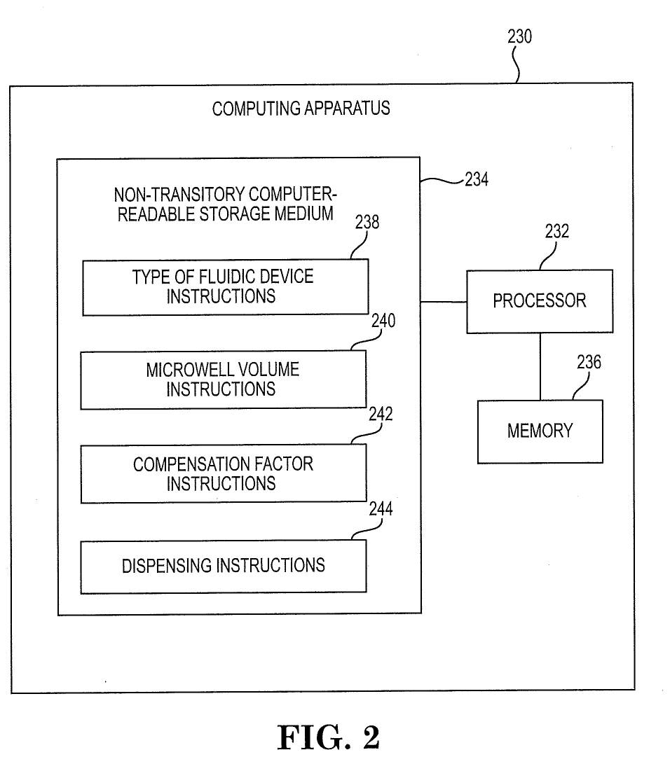

FIG. 2 is a diagram illustrating an example computing apparatus for normalizing fluid in a fluidic device, consistent with the present disclosure. In the example of FIG. 2, the computing apparatus 230 may include a processor 232 and a non-transitory computer-readable storage medium 234, and a memory 236. The non-transitory computer-readable storage medium 234 further includes instructions 238, 240, 242, and 244 for normalizing fluid in a fluidic device. The computing apparatus 230 may be, for example, a printer, a mobile device, multimedia device, a secure microprocessor, a notebook computer, a desktop computer, an all-in-one system, a server, a network device, a controller, a wireless device, or any other type of device capable of executing the instructions 238, 240, 242, and 244. In certain examples, the computing apparatus 230 may include or be connected to additional components such as memory, controllers, etc.

The processor 232 may be a central processing unit (CPU), a semiconductor-based microprocessor, a graphics processing unit (GPU), a microcontroller, special purpose logic hardware controlled by microcode or other hardware devices suitable for retrieval and execution of instructions stored in the non-transitory computer-readable storage medium 234, or combinations thereof. The processor 232 may fetch, decode, and execute instructions 238, 240, 242, and 244 to compensate for evaporation in a fluidic device, as discussed with regards to FIG. 1. As an alternative or in addition to retrieving and executing instructions, the processor 232 may include at least one integrated circuit (IC), other control logic, other electronic circuits, or combinations thereof that include a number of electronic components for performing the functionality of instructions 238, 240, 242, and 244.

Non-transitory computer-readable storage medium 234 may be an electronic, magnetic, optical, or other physical storage device that contains or stores executable instructions. Thus, non-transitory computer-readable storage medium 234 may be, for example, Random Access Memory (RAM), an Electrically Erasable Programmable Read-Only Memory (EEPROM), a storage device, an optical disc, etc. In some examples, the computer-readable storage medium 234 may be a non-transitory storage medium, where the term ‘non-transitory’ does not encompass transitory propagating signals. As described in detail below, the non-transitory computer-readable storage medium 234 may be encoded with a series of executable instructions 238, 240, 242, and 244. In some examples, non-transitory computer-readable storage medium 234 may implement a memory 236 to store and/or execute instructions 238, 240, 242, and 244. Memory 236 may be any non-volatile memory, such as EEPROM, flash memory, etc.

In various examples, the non-transitory computer-readable storage medium 234 stores instructions 238 that, if executed, cause the processor 232 to identify a type of fluidic device received by a test system, and a test protocol associated with the fluidic device. For instance, the computing apparatus 230 may receive information identifying a type of fluidic device to be used for fluid dispensing. The fluidic device may include a plate or substrate including a plurality of microwells. Additionally, a cartridge or other component may be received and/or identified. Similarly, a type of protocol and/or assay to be performed may be identified. The type of assay and/or protocol may be identified based on the identification of the type of fluidic device, by manual input, or by other means.

The microwell instructions 240, when executed by the processor 232, may cause the processor 232 to, responsive to an initial dispensing into a plurality of microwells in the fluidic device, determine, for each microwell among the plurality of microwells in the fluidic device, a volume of fluid dispensed. For instance, the amount of fluid in each respective microwell may be measured via optical assessment, laser profilometry, fluorescence, and/or other measurement techniques.

The compensation factor instructions 242, when executed by the processor 232, may cause the processor 232 to determine, for each microwell among the plurality of microwells, a compensation factor for the respective microwell including an amount of an additional fluid to dispense in the respective microwell to compensate for the variations in the initial dispensing. For example, if the fluidic device includes 1536 microwells, an amount of fluid dispensed into each microwell may be determined for each of the 1536 microwells. Similarly, a compensation factor may be identified for each of the 1536 microwells. In some examples, the compensation factor may be a same volume of fluid for a row or microwells. Yet further, the compensation factor may be different for each respective microwell.

The dispensing instructions 244, when executed by the processor 232, may cause the processor to dispense the additional fluid in the plurality of microwells and according to the plurality of compensation factors.

In various examples, the computing apparatus 230 further includes instructions that, if executed, cause the processor to determine the compensation factor based on the test protocol associated with the fluidic device. For instance, polymerase chain reaction (PCR) may include a first set of reagents that evaporate at a first rate, whereas an antibody assay may include a second set of reagents that evaporate at a second rate. Accordingly, the compensation factor for PCR may differ from the compensation factor for the antibody assay. As such, the compensation factor, and therefore, the additional fluid applied, may differ based on the type of test protocol or assay associated with the fluidic device and/or being performed by the fluidic device. Similarly, the computing apparatus may include instructions that, if executed, cause the processor to determine the compensation factor for each respective microwell based on the test protocol associated with the fluidic device.

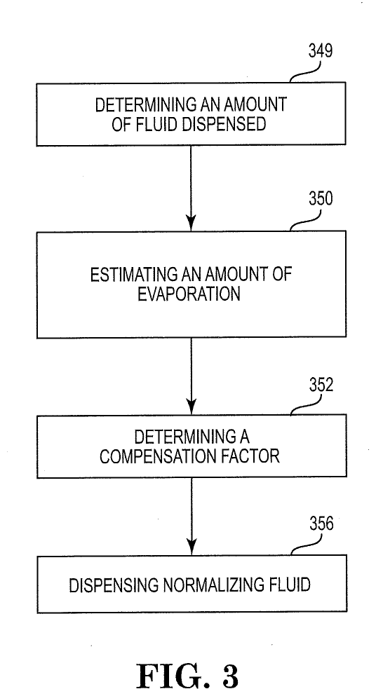

FIG. 3 is a flow chart illustrating an example method for normalizing fluid in a fluidic device, in accordance with the present disclosure. At 349, the method includes determining an amount of fluid dispensed in each microwell. For instance, responsive to an initial dispensing into a plurality of microwells of a fluidic device, a volume of fluid dispensed may be determined for each microwell among the plurality of microwells. At 350, the method includes estimating an amount of evaporation. For each microwell among a plurality of microwells in a fluidic device, an amount of evaporation of the volume dispensed in the respective microwell, may be determined based on the volume in the respective microwell, and an amount of time after dispensing the volume in the respective microwell. At 352, the method includes determining a compensation factor for each respective microwell including an amount of additional fluid to dispense in the respective microwell to compensate for variations in the initial dispensing. At 356, the method includes dispensing the additional fluid in the respective microwell and a volume of oil to each respective microwell to compensate for the estimated amount of evaporation and for variations in the initial dispensing.

As discussed herein, different types of devices and different assays and/or test protocols may be associated with different rates of evaporation and therefore different normalization profiles. Accordingly, the method may include identifying a first normalization profile for the fluidic device. The first normalization profile may include an association between the fluidic device, the compensation factors for the plurality of microwells, and a first type of protocol to be implemented with the fluidic device. Similarly, the method may include identifying a second normalization profile for the fluidic device, including an association between the fluidic device, the compensation factors for the plurality of microwells, and a second type of protocol to be implemented with the fluidic device different than the first type of protocol. As such, different assays and/or protocols may be performed using a same type of fluidic device, and therefore, different normalization profiles may be associated with the same fluidic device.

In various examples, the method includes receiving the fluidic device in a dispensing apparatus. For instance, the fluidic device may include a microplate including a matrix of microwells. Furthermore, the method may include dispensing the volume in each of the plurality of microwells using a first nozzle array of the dispensing apparatus, and dispensing oil in each of the plurality of microwells using a second nozzle array of the dispensing apparatus.

The skilled artisan would recognize that various terminology as used in the Specification (including claims) connote a plain meaning in the art unless otherwise indicated. As examples, the Specification describes and/or illustrates aspects useful for implementing the claimed disclosure by way of various structure, such as circuits or circuitry selected or designed to carry out specific acts or functions, as may be recognized in the figures or the related discussion as depicted by or using terms such as device, system, and/or other examples. See, e.g., reference numerals 101, 103, and 105 of FIG. 1. It will also be appreciated that certain of these blocks may also be used in combination to exemplify how operational aspects (e.g., steps, functions, activities, etc.) have been designed, arranged. Whether alone or in combination with other such blocks (or circuitry including discrete circuit elements such as transistors, resistors etc.), these above-characterized blocks may be circuits configured/coded by fixed design and/or by (re)configurable circuitry (e.g., CPUs/logic arrays/controllers) and/or circuit elements to this end of the corresponding structure carrying out such operational aspects. In certain examples, such a programmable circuit refers to or includes one or more computer circuits, including memory circuitry for storing and accessing a set of program code to be accessed/executed as instructions and/or (re)configuration data to perform the related operation, as may be needed in the form of carrying out a single step or a more complex multi-step algorithm. Depending on the data-processing application, such instructions (and/or configuration data) can be configured for implementation in logic circuitry, with the instructions (via fixed circuitry, limited group of configuration code, or instructions characterized by way of object code, firmware and/or software) as may be stored in and accessible from a memory (circuit).

Based upon the above discussion and illustrations, those skilled in the art will readily recognize that various modifications and changes may be made to the various examples without strictly following the exemplary examples and applications illustrated and described herein. Such modifications do not depart from the true spirit and scope of various aspects of the disclosure, including aspects set forth in the claims.

What is claimed is:

1. An apparatus, comprising:
an assessment circuit to determine an amount of evaporation of a volume initially dispensed in a microwell of a fluidic device, wherein the amount of evaporation is determined based on the volume in the microwell
a compensation circuit to:
determine, based on the amount of evaporation, a compensation factor for the microwell including an amount of additional fluid to dispense in the microwell; and
create a normalization profile for the fluidic device, including an association between the fluidic device and the compensation factor; and
a dispensing circuit to dispense the normalizing fluid in the microwell according to the nominalization profile.

2. The apparatus of claim 1, further including the compensation circuit to determine a compensation factor for the microwell including an amount of oil to be dispensed to the microwell to minimize evaporation for a particular assay performed by the fluidic device, or for a particular type of fluidic device.

3. The apparatus of claim 2, further including the assessment circuit to:
retrieve the normalization profile from a memory in response to identification of the fluidic device; and
dispense the oil to the microwell in response to retrieval of the normalization profile from the memory.

4. The apparatus of claim 1, wherein the volume dispensed in the microwell includes a test sample, the dispensing circuit further including a test sample dispensing circuit to dispense the test sample in the microwell and a normalization dispensing circuit to dispense normalization fluid in the microwell according to the normalization profile.

5. A non-transitory computer-readable storage medium storing instructions that, if executed, cause a processor to:
identify a type of fluidic device received by a test system, and a test protocol associated with the fluidic device;
responsive to an initial dispensing into a plurality of microwells in the fluidic device, determine, for each microwell among the plurality of microwells in the fluidic device, a volume of fluid dispensed;
determine, for each microwell among the plurality of microwells, a compensation factor for the respective microwell including an amount of additional fluid to dispense in the respective microwell to compensate for variations in the initial dispensing; and
dispense the additional fluid in the plurality of microwells and according to the plurality of compensation factors.

6. The non-transitory computer-readable storage medium of claim 5, further including instructions that, if executed, cause the processor to determine, for each microwell among the plurality of microwells, the volume of fluid dispensed in the initial dispensing by an optical assessment.

7. The non-transitory computer-readable storage medium of claim 5, further including instructions that, if executed, cause the processor to determine, for each microwell among the plurality of microwells, the volume of fluid dispensed in the initial dispensing using laser profilometry.

8. The non-transitory computer-readable storage medium of claim 5, further including instructions that, if executed, cause the processor to determine, for each microwell among the plurality of microwells, the volume of fluid dispensed in the initial dispensing using laser fluorescence.

9. The non-transitory computer-readable storage medium of claim 5, further including instructions that, if executed, cause the processor to determine, for each microwell among the plurality of microwells, the volume of fluid dispensed in the initial dispensing by measuring a shape or depth of a meniscus in the respective microwell.

10. The non-transitory computer-readable storage medium of claim 5, further including instructions that, if executed, cause the processor to determine the compensation factor for each respective microwell based in part on the test protocol associated with the fluidic device.

11. A method, comprising:
responsive to an initial dispensing into a plurality of microwells of a fluidic device, determining, for each microwell among the plurality of microwells, a volume of fluid dispensed;
estimating for each microwell among a plurality of microwells in a fluidic device, an amount of evaporation of the volume dispensed in the respective microwell, based on the volume in the respective microwell, and an amount of time after dispensing the volume in the respective microwell;
determining a compensation factor for each respective microwell including an amount of normalizing fluid to dispense in the respective microwell to compensate for variations in the initial dispensing; and
dispensing the normalizing fluid in the respective microwell to compensate for the estimated amount of evaporation and for variations in the initial dispensing.

12. The method of claim 11, wherein dispensing the normalizing fluid includes dispensing a volume of oil to each respective microwell.

13. The method of claim 11, including identifying:
a first normalization profile for the fluidic device, including an association between the fluidic device, the compensation factors for the plurality of microwells, and a first type of protocol to be implemented with the fluidic device; and
a second normalization profile for the fluidic device, including an association between the fluidic device, the compensation factors for the plurality of microwells, and a second type of protocol to be implemented with the fluidic device different than the first type of protocol.

14. The method of claim 11, including:
receiving the fluidic device in a dispensing apparatus; and
dispensing the volume in each of the plurality of microwells using a first nozzle array of the dispensing apparatus, and dispensing the normalizing fluid in each of the plurality of microwells using a second nozzle array of the dispensing apparatus.

15. The method of claim 11, including:
determining, for each microwell among the plurality of microwells, the volume of fluid dispensed using an optical assessment, laser profilometry, fluorescence, or combinations thereof.
